(19) United States
(12) Patent Application Publication
(10) Pub. No.: US 2008/0065633 A1
(43) Pub. Date: Mar. 13, 2008

(54) Job Search Engine and Methods of Use

(75) Inventors: Tong Luo, Sunnyvale, CA (US); Peter Weck, Atherton, CA (US); Antony Sequeira, San Mateo, CA (US); Neelesh Tendulkar, Newark, CA (US); Shai Bentov, Sunnyvale, CA (US); James Levine, Mountain View, CA (US)

Correspondence Address: MACPHERSON KWOK CHEN & HEID LLP, 2033 GATEWAY PLACE, SUITE 400, SAN JOSE, CA, 95110, US

(73) Assignee: Simply Hired, Inc.

(21) Appl. No.: 11/853,769

(22) Filed: Sep. 11, 2007

Related U.S. Application Data
(60) Provisional application No. 60/825,271, filed on Sep. 11, 2006.

(51) Int. Cl. G06F 17/30

(52) U.S. Cl. 707/6; 707/7; 707/E17.008; 707/E17.01

(57) ABSTRACT

A method of accumulating, processing, and classifying online job listings for searches by users. Job listings are automatically, and more effectively, categorized, allowing users to more quickly and easily search job listings. Also provided are expanded tools for more powerful job searching. First, online job listings are automatically accumulated and stored in a job database, such as by web crawlers or robots. The accumulated job listings are then “normalized,” i.e., additional metadata are appended to the stored job listings, which assists in both classifying jobs and in subsequent user searches. These normalized, or augmented, job listings are then classified into job categories by an automated classifier. Assigning jobs to categories in this manner allows for greater search functionality. For instance, users can search by job category, and find additional search terms via other jobs in the same category.

This application claims the benefit of U.S. Provisional Application Ser. No. 60/825,271, filed on Sep. 11, 2006 and entitled “Job Search Engine,” which is hereby incorporated by reference in its entirety.

### BRIEF DESCRIPTION OF THE INVENTION

This invention relates generally to search engines. More specifically, this invention relates to job search engines and methods for their use.

### BACKGROUND

The advent of search engines, particularly Internet-based search engines, has provided significant improvements in access to information of all kinds. However, many general-purpose search engines are not tailored to perform well in particular applications, and thus suffer from relatively poor performance in certain uses. For example, some general-purpose search engines are not specifically designed to handle applications like job searches or searches of employment listings, which present particular challenges such as duplicate listings of the same job by different services, widely different descriptions for the same or similar job, and difficulty in classifying similar jobs having varying job descriptions. It is therefore desirable to offer a search service more closely tailored to handle these and other challenges posed by job searches, so as to offer job-related search services with greater performance and/or functionality relative to general-purpose search engines.

An additional drawback of general-purpose search engines is their lack of specialized tools for particular applications. Most general search engines only offer the ability to search by keyword, and view/access links to returned documents. Other functionality, such as tools specifically designed to improve the job search process, simply do not exist. Accordingly, it is also desirable to offer a search service that offers tools specifically designed to improve and/or streamline job searches.

### SUMMARY

The invention can be implemented in numerous ways, including as a method and as a system. Various embodiments of the invention are discussed below.

In one embodiment, a method of categorizing job listings comprises accumulating a plurality of data sets corresponding to a plurality of job listings, and appending metadata to the data sets. The metadata comprises information describing the job listings, wherein the information of the metadata conforms to a predetermined format. The method also includes categorizing the data sets of the plurality of data sets according to a predetermined taxonomy, the taxonomy corresponding to a set of job categories.

In a further embodiment, a method of categorizing job listings comprises accumulating a plurality of data sets corresponding to a plurality of job listings, and classifying the data sets of the plurality of data sets according to a predetermined taxonomy, the taxonomy corresponding to a set of job categories. The method also includes providing a search engine configured to facilitate job searches by searching the classified data sets.

In a further embodiment, a system for categorizing job listings comprises one or more processors, and a memory coupled to one or more of the processors comprising instructions executable by one or more of the processors. The instructions comprise a normalizer operative to append metadata to a plurality of data sets corresponding to a plurality of job listings, the metadata conforming to a predetermined format, and a classifier operative to classify the plurality of data sets according to predetermined categories. The instructions also comprise a user interface operative to display ones of the data sets retrieved from a search of the plurality of data sets according to the appended metadata.

Other aspects and advantages of the invention will become apparent from the following detailed description taken in conjunction with the accompanying drawings which illustrate, by way of example, the principles of the invention.

### BRIEF DESCRIPTION OF THE DRAWINGS

For a better understanding of the invention, reference should be made to the following detailed description taken in conjunction with the accompanying drawings, in which:

FIG. 1 illustrates an exemplary system for executing job searches according to embodiments of the present invention.

FIG. 2 illustrates a job search server of the exemplary system of FIG. 1.

FIG. 3 illustrates steps taken in accumulating and processing job listings for job searches by users.

FIG. 4 illustrates steps taken in classifying job listings that have been processed according to FIG. 3.

FIG. 5 is an exemplary display of filtering functions as displayed in a user interface constructed in accordance with embodiments of the present invention.

FIG. 6 is an exemplary display of an “Also Found At” function as displayed in a user interface constructed in accordance with embodiments of the present invention.

FIG. 7 is an exemplary display of suggestion functions as displayed in a user interface constructed in accordance with embodiments of the present invention.

Like reference numerals refer to corresponding parts throughout the drawings.

### DETAILED DESCRIPTION OF EMBODIMENTS OF THE INVENTION

The invention relates to a method of accumulating, processing, and classifying online job listings for searches by users. In this manner, job listings are automatically, and more effectively, categorized, allowing users to more quickly and easily search job listings. The invention also provides expanded tools for more powerful job searching. First, online job listings are automatically accumulated and stored in a job database, such as by web crawlers or robots. The accumulated job listings are then “normalized,” i.e., additional metadata are appended to the stored job listings, which assists in both classifying jobs and in subsequent user searches. These normalized, or augmented, job listings are then classified into job categories by an automated classifier. Assigning jobs to categories in this manner allows for greater search functionality. For instance, users can search by job category, and find additional search terms via other jobs in the same category.

The invention also includes training methods for the classifier. In particular, a modified support vector machine is employed as the classifier itself. The job listings in the job database are represented in vector fashion, and the listings are then divided into a training set and a validation set. The support vector machine is trained on the training set and verified on the validation set, whereupon it is used to automatically classify the job listings in the job database. Each of the job listings having been properly classified, users can then search the job database more effectively.

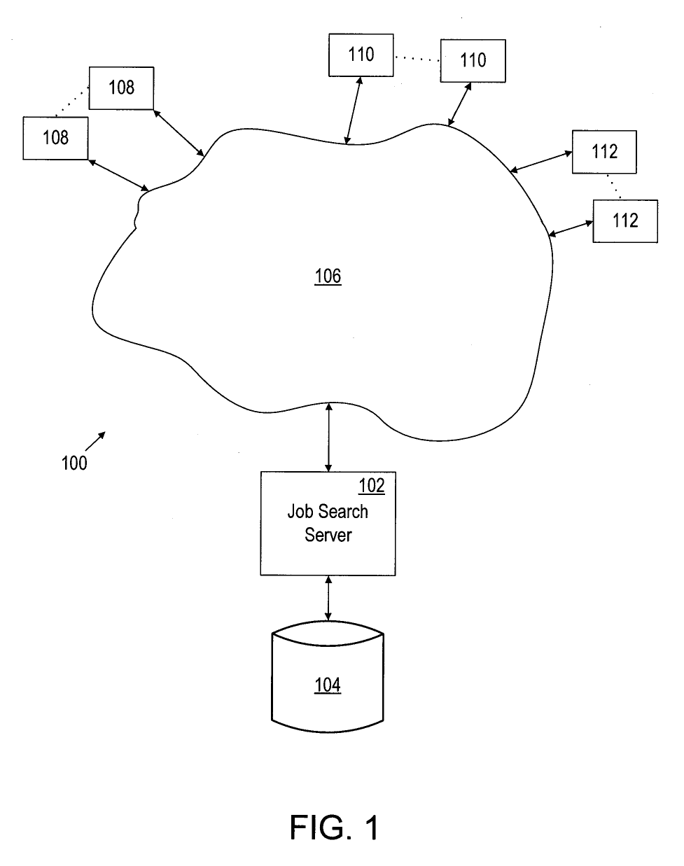

FIG. 1 illustrates an exemplary system for executing job searches according to embodiments of the present invention. A system 100 includes a job search server 102 and database 104. The job search server 102 communicates across a computer network 106 (which can be any computer network, such as the Internet) with various other computers. For example, the job search server 102 communicates with job listings computers 108 which host information on job listings. As will be further explained below, the job search server 102 retrieves job listings from these job listing computers 108. The job search server 102 also communicates with job feed computers 110 that feed job listings to the job search server 102. Note that the job feed computers 110 are to be contrasted with the job listings computers 108: the job search server 102 actively searches out and retrieves job listings from job listings computers 108, while job feed computers 110 actively feed job listings to the server 102. In exemplary embodiments, the job listings computers 108 can be servers for companies listing their job openings, and the job feed computers 110 can be servers for organizations that have previously agreed to send their job listings to the job search server 102, perhaps in a predetermined format for ease of use by the job search server 102, and perhaps for compensation. Additionally, user computers 112 allow users to access job search server 102 to search for job listings stored in the database 104.

In operation, the job search server 102 retrieves job listings from job listings computers 108. The job search server 102 also receives job listings sent by job feed computers 110. These job listings are accumulated and stored in the database 104, whereupon they are normalized, further processed as necessary, and classified according to job category. Users can then search the categorized jobs via the search server 102.

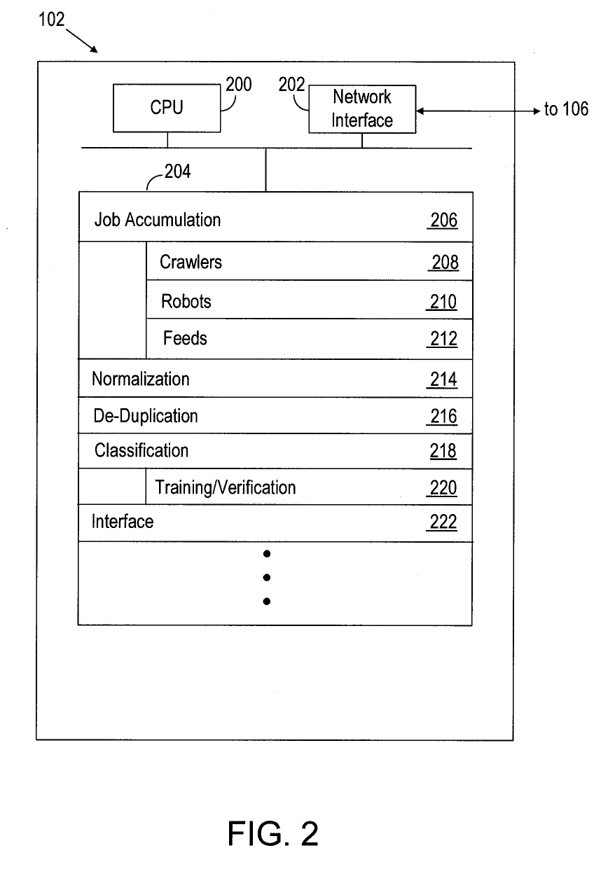

FIG. 2 illustrates further details of job search server 102. The server 102 can be a known server computer having a central processing unit (CPU) 200, network interface 202, and memory 204. The memory 204 can store data and programs for execution by the CPU 200. One such program, or code module, is a job accumulation module 206 that accumulates job listings. The job accumulation module 206 includes a number of sub-modules each accumulating jobs in a specified manner. These sub-modules include web crawlers 208, robots 210, and a job feed sub-module 212.

The web crawlers 208 are known programs that “crawl” specified websites for posted jobs, and retrieve information on these jobs for the job search server 102. In some embodiments, the crawlers 208 can be customized to visit specified websites, look for information having formats characteristic of those websites (i.e., job listings written in formats characteristic of those particular sites), and retrieve this information. The use of crawlers 208 can be advantageous in accumulating job information from known websites containing large numbers of job postings, as the crawlers 208 can be relatively easily programmed to visit specific sites, such as newspaper sites, that contain numerous job postings. The invention contemplates crawlers 208 programmed to visit any specified websites, and retrieve job listings having any format.

The robots 210 are known programs similar to web crawlers 208. Robots 210 can be programmed to visit and retrieve specified websites for further processing, in this case extracting job listings and the like. Processing can be carried out by the server 102, or the robot 210 itself.

The job feed sub-module 212 is designed to receive job listings sent by other computers such as job feed computers 110. In particular, parties can enter into agreements whereby job feed computers 110 (from organizations having job openings) can send job listings directly to server 102, often in a specified format, for processing and storage in the database 104 by job feed sub-module 212. These direct job feeds are desirable in that they eliminate the need for crawlers 208 or robots 210 to find these job listings, and for the further reason that the direct job feeds are often already in a desired format.

Job search server 102 also includes a normalization module 214. This module seeks to “normalize” certain portions of the job listings stored in the database 104, so that these portions of the job listings all reflect common data formats. For example, the normalization module 214 can normalize the location data for each job listing so that each job listing states a city and state where the job would be located. This can include normalizing city/state information to a particular format, such as two-letter standard abbreviations for each state, and standard formats for city names. For instance, the normalization module 214 can be programmed to normalize “Mtn View, CA,” “Mountain View, CA,” and “Mountain View, California” to the common format “Mountain View, CA.” Common data formats like this make subsequent processing and job searching much easier and more effective, as users can execute a single search based on one city/state name, rather than multiple searches for each variation thereof.

Job search server 102 also includes a de-duplication module 216 that determines whether job listings are duplicates of each other. Duplicate job listings can then be deleted or noted in search results. The server 102 further includes a classification module 218 that classifies jobs into categories. This allows users to search by job category. The classification module 218, in some embodiments, is a classifier program that, once trained, automatically classifies accumulated job listings into predefined categories. The configuration, training, and operation of one such classifier is described further below, and can employ a training and verification sub-module 220.

The job search server 102 also includes an interface module 222 that provides a user interface for user computers 112. The interface module 222 can be programmed to provide features facilitating faster and more effective job searches, as will be further described below.

The various modules 206-222 are shown as residing on the same server 102 for purposes of clarity and ease of explanation. However, one of ordinary skill in the art will realize that this need not be the case, and multiple different servers 102 can be employed to execute different modules 206-222 and carry out different functions in support of the invention.

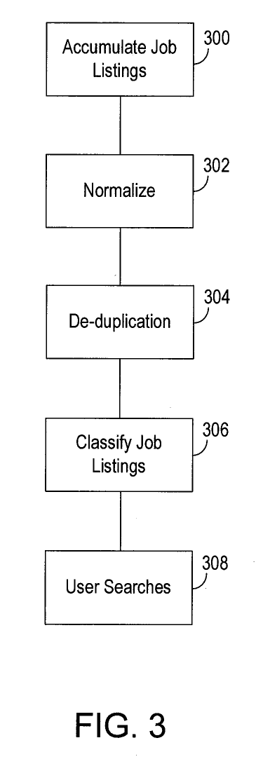

Prior to being made available for user searches, job listings are first accumulated, then normalized so that their information conforms to predetermined formats, de-duplicated to remove/flag duplicate job listings, and classified. FIG. 3 illustrates this process. Job listings are first accumulated (step 300). As above, job listings can be collected by crawlers 208 and robots 210, and can also be automatically sent to the job listing server 102, where they are received by job feed module 212. The accumulated job listings are then stored as data sets in database 104, whereupon they are normalized (step 302). During step 302, the normalization module 214 parses each of the data sets for text describing various attributes of the job in question, and appends metadata corresponding to these attributes. The appended metadata are of a predetermined format, so that the resulting data sets are essentially modified to include a set of job information in a common format. As one example, the normalization module 214 can determine the name of the company listing the job opening, as well as the city/state the job is in. The normalization module 214 can then append to the job's data set metadata listing the company name and job location, both in prescribed formats. In this manner, every data set can list information such as this in a standardized, or normalized, form.

Once the data sets corresponding to the job listings are normalized, de-duplication can occur (step 304). In one embodiment, duplicate job listings are determined by mapping each job listing to a vector (further described below), and calculating the distance between vectors. Vectors that are within a sufficiently small vector distance from one another are deemed identical. The remaining jobs are then classified (step 306) into predetermined categories by a classifier, whereupon they can be searched by users (step 308), typically through the user interface 222.

Attention now turns to a more detailed description of the normalization, de-duplication, classification, and user search steps.

Normalization

The normalization step 302 seeks to provide a standard format for reporting job listing information, so that users can capture all desired job listings with relatively few searches. To that end, the normalization module 214 appends metadata to each data set, where the metadata reflects job listing information in a predetermined standardized format. The invention contemplates appending any form of metadata or other supplementary information, in any format, so long as it provides a common format for job searches.

In one exemplary embodiment, the accumulated job listings are represented as data sets. Each data set is a collection of information within its job listing, in any convenient format. The normalization module 214 is programmed to scan or parse the text of the data set for the appropriate information, and append the same, or supplementary, information in a specified format. That is, job listings can be parsed for job location information, the precise text of which can vary widely in format, and append the same information in a single, standardized format. Thus, for example, the text of a job listing can be scanned for any of the following: “San Francisco,” “S.F.,” or “San. Fran.” If any of these text strings are found, the module 214 can append metadata containing the normalized string “San Francisco, Calif.” to the job's data set.

One of ordinary skill in the art will realize that the normalization module 214 can scan text and detect strings of job information in any known manner, including comparing text strings to a database of stored text strings. These stored text strings can be, for instance, a list of regular or common expressions and their corresponding normalized text. Similarly, the module 214 can discriminate between “true” job information such as a job's true location (e.g., “job location: San Francisco”) and “false hits” such as information that may appear to list a job's true location but in fact does not (e.g., “job requires frequent travel to San Francisco”), in any manner, including programming the web crawlers 208 and robots 210 to extract location information, and other information of interest, from specified locations in the web pages they visit, and place it into specific data fields in the data sets. The module 214 can also utilize probabilistic methods, such as determining location (or other) information from special characters, bolded/italicized text or other HTML markups, checks for the position where terms appear in the text, or checks for adjacent terms. These latter two approaches can be employed with the assistance of the job listings stored in database 104. That is, the stored job listings can be scanned to determine the probabilities that information such as location information is present in a specific portion of a job listing. The module 214 can also utilize learning or other intelligent algorithms, and the like.

One of ordinary skill in the art will also realize that the normalization module 214 can append any type of information to the data sets. For instance, the module 214 can append location information, dates of interest, salary ranges, company names, and the like. In this manner, it can be seen that appended data fields such as these can represent added information that serves to standardize and augment relevant information in various job listings.

A problem arises when job listings are incomplete, inaccurate, or provide insufficient information for the normalization module 214 to append information solely taken from the text of the job listing. In that event, it is sometimes beneficial to verify the information in job listings, and append further information derived in some other manner. In one exemplary embodiment, job listings are parsed as above to determine relevant job information, such as job location. This information is then placed in data fields as appropriate. Using job location as an example, the module 214 can utilize any one or more of the following data fields: location_all, location_address, location_city, location_state, location_zip, and location_country. As above, each of these data fields is filled in with the appropriate text taken from the job listing. If the job listing has sufficient information within its text to fill in each of these fields, normalization can simply consist of appending metadata containing each of these data fields, perhaps in standardized form. For instance, while the invention contemplates any sets of standardized information, the following standardized information can be appended for each data field:

location_city—“San Francisco” instead of “SF,” “San. Fran.,” etc.

location_state—“CA” instead of “California,” “Calif.,” etc.

location_zip—“11111” instead of “11111-2222,” etc.

location_country—“U.S.” instead of “United States,” “U.S.A.,” etc.

Other data fields can be appended in similar fashion, reflecting other attributes such as company names. However, information for all of these data fields may not exist within some job listings, or may be incorrect or otherwise unreliable. Accordingly, the normalization module 214 can also attempt to supplement or verify the information within the job listing, utilizing other sources of information. In particular, the normalization module 214 can, in some embodiments, consult stored tables of information, such as tables that list the city and state of each zip code. In this manner, the normalization module 214 can append city and state information when a job listing only lists a zip code, or append corrected zip code information if proper location information is listed but the zip code is incorrectly shown. In other embodiments, the module 214 can consult external programs such as Geo::Coder::US, an Openware program that produces as output coordinate information such as latitude and longitude, i.e., geocoding information, for any U.S. address input.

One embodiment of module 214 that utilizes Geo::Coder::US can execute the following process for supplementing information in job listings. If location_address contains an address, Geo::Coder::US is used to determine the corresponding latitude and longitude of that address, i.e., “normalized” latitude and longitude. If no address is available, or if Geo::Coder::US does not have a valid latitude/longitude for the address, but if location_zip contains a zip code, module 214 consults a stored table listing address information (or other useful information, such as latitude/longitude of a representative location within that zip code, area code, state, county, FIPS code, etc.) by zip code. If available, “normalized” address information from this table is retrieved. Such tables are known, and can be stored in memory 204 or database 104.

The module 214 then attempts to verify that this normalized information is the information that should be used. If retrieved, normalized city/state/zip information is compared to location_city, location_state, and location_zip. If a match exists with all three, all normalized information is deemed accurate and appended as metadata. If not all three match, or if not all city/state/zip information is present, the module 214 then attempts to compare just the normalized city/state information to location_city and location_state. If both match (i.e., the job listing's city/state information is accurate but its listed zip code is not), location_zip is overwritten/appended with the normalized zip code if one exists. Here, normalized zip code information can be taken from, for example, city/state/zip code mappings such as those offered by various services including the US Postal Service. If multiple zip codes match this city/state, the module 214 can select as the normalized zip code that zip code that is in the geographic center (geocenter) of the city listed. If one zip code matches to multiple cities, the city can be selected according to the US Postal Service's default (“D”) entry for that city/state (as stored in a database or retrieved from a US Postal Service server).

If a city/state match cannot be found, a match is attempted comparing just normalized city/zip information to location_city and location_zip. If both match, the process ends and all normalized location information is appended. Otherwise, the “D” entry for that zip code, or the city at the geo-center of that zip code, can be used as normalized city information.

If no city match can be found in this manner, the module 214 can attempt to match just normalized zip code information with location_zip. If the zip codes match, just the normalized zip code information is appended. If the fields do not match, a city-only match is attempted and, if a match exists, the normalized city information is appended. If multiple city matches exist, the city corresponding to the “D” entry is appended if available. The city at the geo-center of available zip code information may also be used if the “D” entry is not available. The city matching any state information within location_all may also be used, if this information is available.

If no match can be found, a state-only match may then be tried, in similar manner. If a state match exists, normalized state information is appended. If not, the job listing is discarded as unreliable or providing insufficient information to be properly verified.

One of ordinary skill in the art will also realize that known accumulated information may also be used to augment the above process. For example, the process can also employ a lookup table of well-known key phrases that can be used to fill in normalized information. This table can be used to map phrases such as “Bay Area” to California, or “Chicagoland” to Illinois, for instance. Such a table can be consulted at any appropriate point in the above process. Similarly, some text strings can be expanded or contracted as necessary (i.e., “Ft.” can be converted to “Fort”), and/or extended zip codes can be removed. One of ordinary skill will also realize that the above described process can include other criteria for discarding jobs deemed unverifiable or unreliable. For instance, a check can be made of location_country, and all non-United States jobs can be discarded if desired. Similarly, listings can be discarded if location_city is too short, or uses non-letters. Any of these steps can occur at any time, although it is often preferable that they occur prior to attempting any matching.

It should also be noted that the above described matching process is only an exemplary process, and the invention contemplates any process (and even none at all) for matching/verifying its normalized information. For example, in countries utilizing other systems besides states and zip codes, matching/normalization can be performed using other data fields, such as location_city, location_county, location_postcode, location_region, location_country, and location_other. Location matching and normalization of location information can then be performed as above, except using these data fields instead. For instance, matches can first be attempted using city/county/postcode information, and so on.

As another example, normalization can also be extended to further enrich the information provided to users. More specifically, after normalization matches information (i.e., verifies its accuracy) and appends supplementary data in a particular format, the normalization module 214 can append further information that a user may find helpful. For instance, once company name information is verified and/or a standardized company name is appended, the normalization module 214 can append further information, such as the line of business the company is in, type of ownership, total revenue, and the like. The invention contemplates the appending of any supplemental information useful to users.

De-Duplication

The de-duplication step 304 seeks to flag duplicate job listings for deletion or other forms of treatment. The de-duplication module 216 first parses accumulated job listings and fills data fields as above. These data fields can be any fields capable of describing or characterizing the job listing, and can commonly include such fields as job title, company name, city, state, and job description. Using these fields, the module 216 can search for two different types of duplicate listings: “intrasource” duplicates, or the same job retrieved multiple times (such as when the same job is listed multiple times on the same website), and “intersource” duplicates, or the same job retrieved from two different sources (such as when robots 210 and crawlers 208 both independently retrieve listings for the same job from different websites).

The de-duplication module 216 can determine intrasource duplicates by matching data fields. In one embodiment, the module 216 can compare the job title, company name, city, state, and job description fields for two different data sets and, if every field matches (perhaps after normalization to standardize the format of each field), the jobs are regarded as the same job and duplicates are deleted. It is often preferable to retain the newest job listing, if that information is available. De-duplication can be performed on normalized data or the data fields can be compared using other methods that do not require exact matches of text strings. For example, the invention contemplates job field comparisons according to algorithms such as a known MD5 algorithm that processes the job fields into fixed-length fields that are sensitive to differences in the original text of the job fields, and thus indicate similarities between corresponding job fields to a relatively high degree of accuracy.

The de-duplication module 216 can determine intersource duplicates by matching data fields. In one embodiment, the module 216 can determine duplicates as above, by determining whether each of job title, company name, city, and state fields for two different data sets are an MD5 match. If so, the job description field is further scanned to determine whether sufficient similarity exists within the job descriptions. This can be accomplished by first eliminating frequently-appearing words (e.g., “stop words” such as articles and prepositions) from each job description field to be compared. A check can then be made to determine whether two job descriptions have at least a predetermined number of consecutive words in common (in one embodiment, this predetermined number can be a minimum of 30 consecutive words). If the compared job listings have a string of at least this number of consecutive words in common after removing stop words, the compared job listings are deemed to be intersource duplicates.

Once duplicates have been determined, a further check can be performed to identify which of the duplicated job listings should be considered as the “master” listing, with the remainder considered as “duplicates.” This determination can be made in any manner, but in one embodiment is determined according to the source of the job listing and its age. More specifically, job listings fed directly from the employer to the job feed sub-module 212 are deemed masters over duplicate listings that come from potentially less-reliable sources such as job boards. If multiple job listings come from the same source, age information (if available) is used as the tie-breaker, with the most recent job listing deemed the master and the older listings deemed duplicates.

Classification

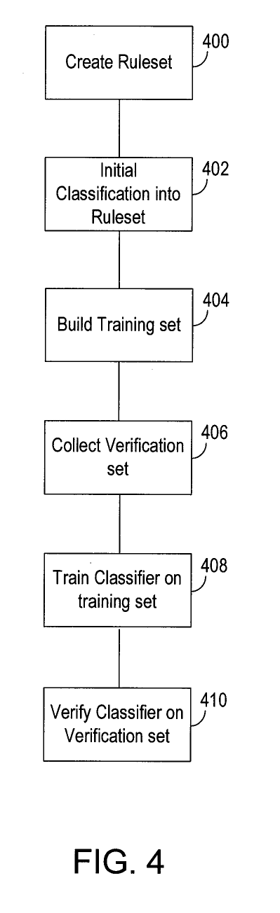

The classification module 218 includes a classifier program capable of automatically classifying accumulated job listings by category. FIG. 4 illustrates process steps taken in the building and training of such a classifier. In order to build a classifier designed to classify job listings according to predetermined categories, a ruleset is first created, establishing the taxonomy of categories used (step 400). In one embodiment, the taxonomy used is the O*Net™ taxonomy of occupations, although the invention contemplates the use of any taxonomy. Once a ruleset is established, a group of job listings are initially classified according to this taxonomy (step 402). From this initial set of classified jobs, a training set (step 404) and verification set (406) are selected. Steps 402-406 can be performed in any manner, including manually, as the training set and verification set need only be of sufficient size to train and verify the classifier, and need not be as large as the set of all jobs accumulated. The training and verification sets having been selected, the classifier program can then be trained on the training set (step 408) and verified on the verification set (410).

It should be noted that the classifier can be any classifier capable of categorizing job listings. However, in one exemplary embodiment, the classifier is a support vector machine. The building, training, and verification of support vector machine classifiers is known. Support vector machines classify vectors according to a likelihood that such vectors fall into specified categories. Accordingly, the building of a training set of vectors (step 404) can be carried out as follows. Each job listing that will be used in either the training set or verification set is converted into a vector of numerical values, and a number of representative job listings/vectors are assigned to particular categories of the taxonomy. The invention encompasses conversions in any known manner, including conversion according to known methods such as a term frequency-inverse document frequency (“tf-idf”) weighting scheme that determines each vector element according to the frequency at which a particular term arises in its job listing. As the various accumulated job listings are of differing lengths, the tf-idf vectors are of differing lengths as well. The vectors are thus length normalized, which again can be carried out via known methods. Once length normalized, a summary vector is computed for each category. The summary vector can be any vector representative of its job category, i.e., a vector “summarizing” or representative of the vectors already assigned to that job category. One embodiment contemplates calculation of each summary vector according to the vector median of all job vectors assigned to that job category.

Once the summary vectors are determined, the remaining job vectors are assigned to different categories by determining inner products between each job vector and the summary vectors. Job vectors can then be assigned to the category corresponding to the largest inner product, i.e., the category whose summary vector bears the greatest similarity to the job vector, although the invention also contemplates any other method for determining the similarity of different vectors. These categorized job vectors form the training set of step 404. Other job listings can also be represented in vector form, to act as the verification set. Of the total number of available job vectors, it is often desirable to reserve as many as possible for the training set, to ensure an accurate classifier. However, it is also desirable to reserve enough job vectors to ensure a validation set that is large enough to effectively validate the classifier once trained. Thus, one rule of thumb is that 10-15% of the available job vectors are to be reserved for the validation set, while the remainder are used in the training set.

The support vector machine is then trained on the training set and verified on the verification set. Training and verification of support vector machines are known. However, the typical approach to training a support vector machine involves optimizing parameters of a cost function of the support vector machine, usually employing quadratic programming methods to do so. The time needed for convergence in this approach is generally a polynomial function of the number of records in the training set. Thus, the typical approach often takes a very long time for large training sets. Accordingly, another approach offering faster convergence includes employing a known stochastic gradient descent search to determine optimal parameters for the cost function of the support vector machine. Further improvement in convergence time can be achieved by removing the regularizer typically used in training of the support vector machine, and instead using the verification set to alleviate the overfitting problem. This method generally achieves convergence time as a linear function of the number of records in the training set.

It should also be noted that the support vector machine itself can be modified from the typical support vector machine, so as to improve its output. That is, the support vector machine classifier can be modified so that its probability estimation in classification of job data, i.e., the output of the support vector machine, can be improved. In particular, a modified least squares function can be employed instead of the typical hinge loss function, as described by Tong Zhang, Statistical Behavior and Consistency of Classification Methods based on Convex Risk Minimization, 32 ANNALS STAT. 56 (2004), which is hereby incorporated by reference in its entirety. This modified least squares function has been shown to provide improved probability estimation compared to hinge loss functions.

The support vector machine having been trained and verified, all job listings stored in database 104 can be represented in vector form and automatically classified. As above, stored data sets are processed by the support vector machine to determine an estimation of the probability that each data set belongs to a particular job category. The data sets/job listings can then be categorized according to the category associated with the highest probability, or a probability above a predetermined threshold. The end result is a database of job listings that have had useful metadata appended, and that have been de-duplicated and classified into categories (such as O*Net™ employment categories).

User Search Features

Once normalization, de-duplication, and classification have occurred, the job listings of the database 104 are in a form that lends itself to easy and effective searching by users. Other search features of the invention also provide additional advantages. That is, once the job listings of the database 104 have been normalized, de-duplicated, and classified, the interface 222 can allow users to search the database 104 by providing standard search features along with additional features that provide additional advantages.

One such feature takes advantage of the appended metadata from the normalization step 302. In particular, a number of filters can be offered to narrow or limit users' search results according to the appended metadata. Filters can thus offer users the ability to narrow searches according to any appended metadata. That is, appended metadata become the criteria by which search results can be filtered. For example, if location, company name, experience level, and company size are appended as metadata, filters can be designed in known fashion to allow users to filter returned job listings according to any of these types of metadata. Thus, if a user's search by the keywords “software engineer” returns 20,000 results, the user can filter these results by any of location, company name, experience level, and company size. This allows the user to filter his or her results by narrowing results to, for example, only Fortune 500 companies in San Diego, that have openings for software engineers with 0-2 years of experience.

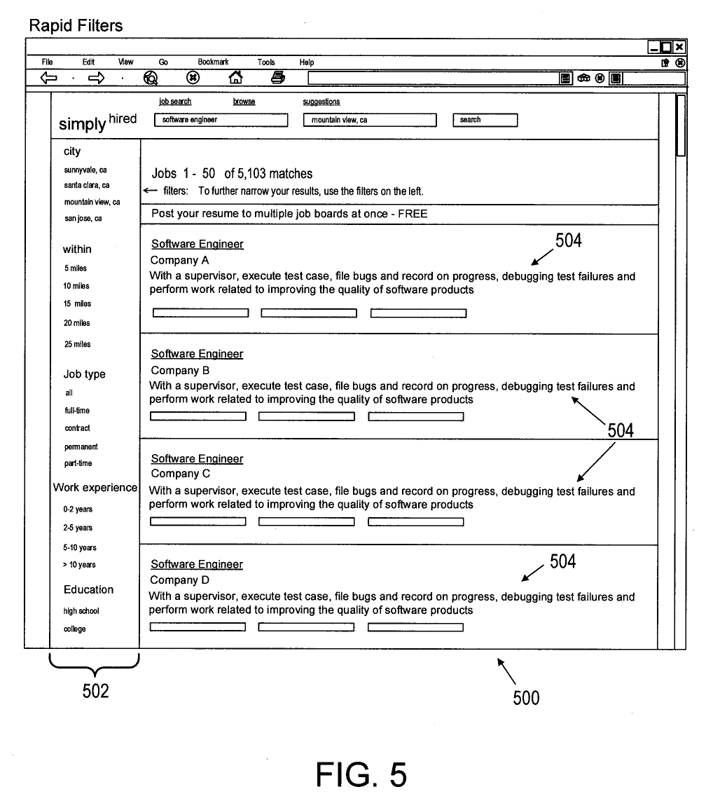

FIG. 5 illustrates an exemplary user interface that makes filtering functions available for the user. In particular, the left hand column 502 of the interface window 500 offers a number of hyperlinks as shown, each corresponding to metadata appended to the job listings. Here, the left hand column 502 includes hyperlinks for location, job type, amount of work experience, and education level required. Users can select these links, and job listings 504 are narrowed accordingly. Here, for example, FIG. 5 displays a list of only those jobs 504 classified as software engineer jobs, and that are located within 25 miles of Mountain View, Calif., 94035. It can be seen that the ability to filter job listings in this manner gives users much more flexibility in narrowing their searches according to many different desirable criteria.

One of ordinary skill in the art will realize that the invention encompasses many different forms for such filters. In known manner, search results can be returned alongside a search box that allows users to enter filter terms, or a set of buttons labeled according to the types of metadata appended. Clicking on the appropriate button or entering a filter term corresponding to the metadata will thus initiate filtering of the returned search results.

Another feature is an “Also Found At” feature utilizing the de-duplication of step 304. Users typically do not wish to see duplicate job listings. However, they may wish to know when duplicate listings exist. Accordingly, an “Also Found At” feature can be offered, in which duplicates determined at step 304 are flagged but not deleted, and the existence of these duplicate listings is presented to the user. That is, if duplicate search results exist, users are shown a list of the duplicates, along with a notation that that job listing is “also found at” other listings. The duplicate listings can be listed as hyperlinks, allowing users to click on, and view, these duplicate listings if desired. In this manner, individuals need not clutter their search results with multiple duplicate listings, but they still retain the option to view the duplicate listings if they wish.

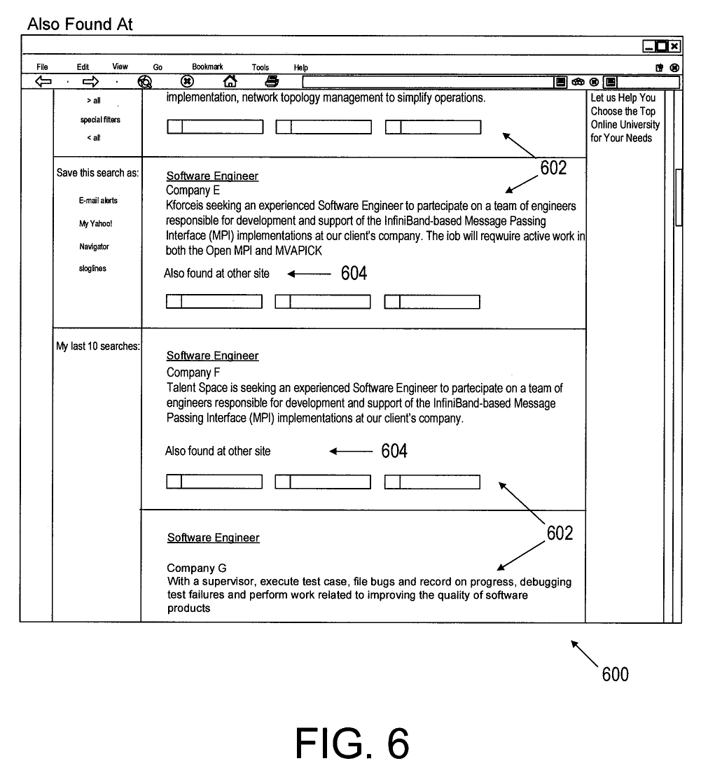

FIG. 6 illustrates an exemplary user interface offering this “Also Found At” feature. Here, UI window 600 displays a listing of job search results 602. Some of these job listings 604 also include an “Also Found At” hyperlink 604 indicating to the user that duplicates of those job listings 604 exist, and allowing the user to see the duplicate listings if desired.

Another feature is the ability to allow users to rate jobs, and to offer suggestions to users based on previous jobs that they have saved and rated. The interface program 222 can offer users the ability to rate job listings, with ratings stored by user in permanent storage or in memory 204, along with information related to highly rated jobs. This information can include the appended metadata of highly rated jobs, as well as the category these jobs were classified into. Based on a user's highly rated jobs, the program 222 can offer users suggestions on other jobs that the user is likely to be interested in. The determination of these suggested jobs can be made in any number of ways, including by retrieving other jobs having the same or similar metadata, by learning algorithms that recognize patterns in the metadata of highly rated jobs, or any other known method of determining patterns in stored metadata or rankings.

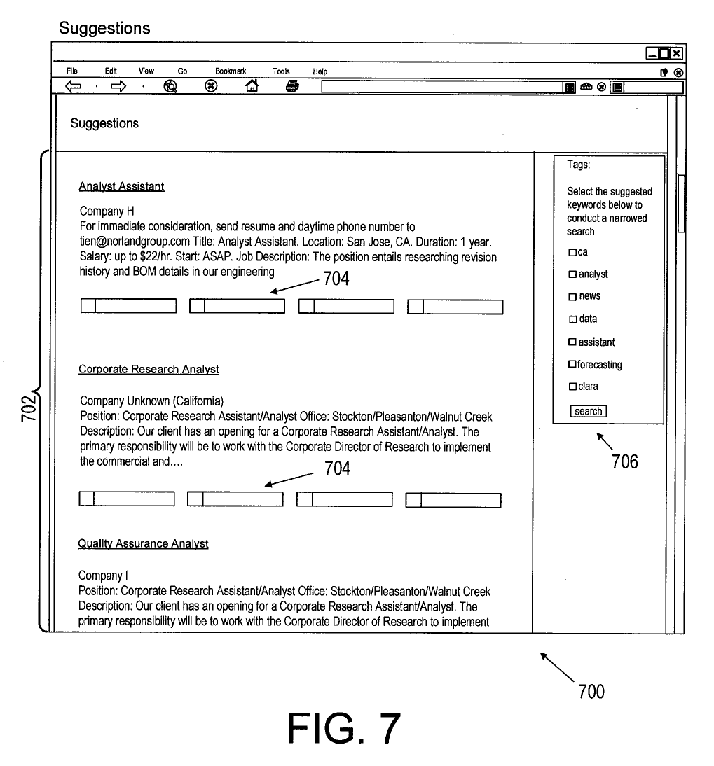

A further feature is a “Who Do I Know?” feature, which can be an icon or button that provides users with information about who they may know at a company with job openings. In particular, the server 102 can connect to another server hosting a social or professional networking website. Clicking the “Who Do I Know?” button can transmit a user's identity and company name to the networking website, which then returns the names of other people who are both listed in that user's social/professional network and work at that company. If the networking website allows determination of more extended networks, then people listed by this feature include people in extended networks who also work at that company. In this manner, the “Who Do I Know?” button can display people who work at that particular company, and who are in the network of anyone in the user's network, or even people in the network of the network of anyone in the user's network. FIG. 7 illustrates an exemplary UI window 700 having job listings 702 that offer “Who Do I Know?” feature buttons 704 allowing users to find other people they know at companies listing jobs they may be interested in. The buttons 704 may be grayed out if, for instance, no one in the user's network works at that particular company, or if the service is otherwise not offered for that particular job listing.

A further feature is the ability to learn further information about the company offering a particular job listing. In particular, normalized data can include both the normalized company name, and further information on this company if available. This information can be appended as further metadata, and can include the location of the company's headquarters, corporate website URL, and statistics about the company, such as size, earnings, and even recent news of note. Such information can be retrieved from a database stored in memory 204 and/or permanent storage, retrieved over the computer network 106 (perhaps from the corporate website or other news websites), or retrieved from/provided by other sources such as third party providers of business data. This appended metadata can be offered to users via an icon or dropdown menu proximate to that particular search result, or in any other known manner convenient to the user.

A final feature is title clustering, or the ability to provide job seekers with suggestions for alternate job titles. With this feature, the server 102 stores keywords the user has entered in his or her searches, and recommends additional keywords as well as additional job titles that the user may be interested in using for further searches. Title clustering can be accomplished in any manner. For example, the server 102 can compile and store a list of the most common job titles for each job category. The server 102 can also store a running list of the job titles that each user clicks/selects, as well as the keywords that users use in their searches. The server 102 then determines which job categories correspond most closely to the stored keyword and job title information (i.e., the categories that selected jobs are from, and the categories that most closely match the stored keywords), and suggests as additional keywords the stored common job titles for those categories.

FIG. 7 illustrates a suggestions window 706 displaying this feature. The window 706 lists a number of keywords, that can be taken from the metadata of the retrieved jobs or from stored keywords or search terms the user has previously entered. The user can then narrow their search according to keywords they select from window 706 or, in other embodiments besides the one shown, can broaden their search and/or conduct new searches by these listed keywords.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. Many modifications and variations are possible in view of the above teachings. For example, the normalizer of the invention can append any useful category of metadata to retrieved job listings. Similarly, the classifier can be any type of classifier capable of classifying jobs according to any predetermined taxonomy. Also, the user interface of the invention can offer any combination or permutation of the features described above. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method of categorizing job listings, comprising:
accumulating a plurality of data sets corresponding to a plurality of job listings;
appending metadata to the data sets, the metadata comprising information describing the job listings, wherein the information of the metadata conforms to a predetermined format;
categorizing the data sets of the plurality of data sets according to a predetermined taxonomy, the taxonomy corresponding to a set of job categories.

2. The method of claim 1, wherein the accumulating further comprises at least one of 1) receiving hypertext documents retrieved by a web robot, 2) receiving hypertext documents retrieved by a web crawler, and 3) retrieving preformatted data corresponding to job listings of the plurality of job listings.

3. The method of claim 1, wherein the information of the metadata includes location information corresponding to geographic locations for the job listings, and company information corresponding to names of hiring companies.

4. The method of claim 2, wherein the location information includes at least one of city and state information, and geocoding information corresponding to a coordinate location for the job listings.

5. The method of claim 1, further comprising determining duplicate data sets corresponding to multiple listings of the same job.

6. The method of claim 1, wherein the categorizing further comprises:
forming a training set from the data sets conforming to categories of the taxonomy; and
training a classifier on the training set, so as to generate a classifier operative to automatically classify the data sets according to the categories of the taxonomy.

7. The method of claim 6:
wherein the data sets of the plurality of data sets are vectors having vector elements corresponding to frequencies at which terms appear within the plurality of job listings; and
wherein the forming further comprises, for each category of the taxonomy, determining a summary vector according to an average of the vector elements of the vectors of that category, and comparing data sets to the summary vector so as to determine ones of the data sets conforming to that category.

8. The method of claim 7, wherein the comparing further comprises:
normalizing lengths of the vectors to a common length;
calculating inner products between the vectors and the summary vectors so as to determine a similarity metric corresponding to a similarity between the vectors and the summary vectors; and
associating the job listings corresponding to the vectors with a job category corresponding to the summary vector, according to the similarity metrics.

9. The method of claim 6, wherein the training further comprises:
forming a validation set from the data sets; and
verifying the classifier on the validation set.

10. The method of claim 6, wherein the classifier is a support vector machine.

11. The method of claim 10, wherein the support vector machine has a loss function that is a modified least squares loss function.

12. A method of categorizing job listings, comprising:
accumulating a plurality of data sets corresponding to a plurality of job listings;
classifying the data sets of the plurality of data sets according to a predetermined taxonomy, the taxonomy corresponding to a set of job categories; and
providing a search engine configured to facilitate job searches by searching the classified data sets.

13. The method of claim 12 wherein the accumulating further comprises at least one of 1) receiving hypertext documents retrieved by a web robot, 2) receiving hypertext documents retrieved by a web crawler, and 3) retrieving preformatted data corresponding to job listings of the plurality of job listings.

14. The method of claim 12 wherein the classifying further comprises running a classifier program trained to automatically classify the data sets according to the categories of the taxonomy.

15. The method of claim 12 wherein the search engine is further configured to return job search results, and wherein the providing further comprises providing a filter feature filtering the job search results according to at least one predetermined criterion.

16. The method of claim 15 wherein the at least one predetermined criterion is at least one of job location, job type, company identity, experience level, and education.

17. The method of claim 12 further comprising providing a de-duplication function determining duplicate ones of the data sets corresponding to multiple listings of the same job, and wherein the providing a search engine further comprises returning a description of the duplicate ones of the data sets.

18. The method of claim 12 further comprising:
receiving rating information corresponding to ratings of selected ones of the job listings by a user of the search engine;
selecting ones of the data sets according to the rating information; and
providing the selected ones of the data sets to the user.

19. The method of claim 12 further comprising:
transmitting user information corresponding to a user of the search engine;
transmitting organization information corresponding to an organization specified by the user; and
receiving personal networking information corresponding to individuals both within a personal network of the user of the search engine and affiliated with the organization specified by the user.

20. The method of claim 12 wherein the search engine is further configured to return job search results, and wherein the method further comprises:
displaying the returned job search results;
receiving a request for organization information identifying an organization providing the job listings of the returned job search results; and
responsive to the receiving, displaying supplementary organization information corresponding to further information describing the identified organization.

21. The method of claim 12 wherein the data sets have job title information corresponding to job titles for the job listings of the data sets, the method further comprising:
responsive to a first search by the search engine, retrieving one or more data sets associated with one of the job categories, the retrieved one or more data sets having a first set of job title information; and
retrieving from the data sets of the associated job category a second set of job title information; and
providing the one or more data sets and the second set of job title information, so as to facilitate a second search by the search engine according to the second set of job title information.

22. The method of claim 21 wherein the second set of job title information is at least one of related job title information and keyword information.

23. The method of claim 12, wherein the classifying further comprises:
comparing data sets from the plurality of data sets to the taxonomy so as to determine ones of the data sets conforming to categories of the taxonomy;
forming a training set from the data sets conforming to categories of the taxonomy; and
training a classifier on the training set, so as to generate a classifier operative to automatically classify the data sets according to the categories of the taxonomy.

24. A system for categorizing job listings, comprising:
one or more processors; and
a memory coupled to one or more of the processors comprising instructions executable by one or more of the processors, the instructions comprising:
a normalizer operative to append metadata to a plurality of data sets corresponding to a plurality of job listings, the metadata conforming to a predetermined format;
a classifier operative to classify the plurality of data sets according to predetermined categories; and
a user interface operative to display ones of the data sets retrieved from a search of the plurality of data sets according to the appended metadata.

25. The system of claim 24 wherein the instructions further comprise a de-duplication module operative to determine duplicate ones of the data sets.
